(19) United States
(12) Patent Application Publication
(10) Pub. No.: US 2007/0164628 A1
(43) Pub. Date: Jul. 19, 2007

(54) Electric transmission for transmitting mechanical power, in particular for a motor vehicle transmission

(75) Inventors: Armando Fonseca, Voisins le Bretonneux (FR); Alex Romagny, Bois d'Arcy (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: RENAULT S.A.S, Boulogne Billancourt (FR)

(21) Appl. No.: 10/576,471

(22) PCT Filed: Oct. 18, 2004
(86) PCT No.: PCT/FR04/50509

§ 371 Date: Jan. 26, 2007

(30) Foreign Application Priority Data
Oct. 21, 2003 (FR) 0312290

(51) Int. Cl. H02K 47/00; H02K 1/12; H02K 1/22

(52) U.S. Cl. 310/112; 310/113; 310/257; 310/266; 310/268

(57) ABSTRACT

An electric transmission, in particular for a motor vehicle, including two electric motors, whereby the shaft of one of the electric motors is connected to a mechanical energy source, the motor converts mechanical energy into electrical energy, the other electric motor converts electrical energy into mechanical energy, and the shaft thereof is connected to the element to be driven. Rotors of both motors are arranged concentrically or axially in relation to each other, and both rotors cooperate with stators, the windings of which are arranged inside the volume defined by both rotors. The windings include several annular windings juxtaposed in volume, the windings being supplied with alternating currents which are out of phase in relation to each other.

The present invention relates to an electric transmission of mechanical power, intended in particular for a motor vehicle transmission.

Transmission of mechanical power between a motive power source and the element to be driven very often necessitates adaptation of speed as a function of the modes of operation.

This is the case in particular for motor vehicles, where the internal combustion engine must be able to drive the wheels from a standstill up to their maximum speed: usually the transmission is then provided with a coupling device that permits at least temporary slipping (friction clutch, electromagnetic powder clutch, hydraulic torque converter) associated with a variable-ratio mechanically geared reduction of movement (gearbox with discrete ratios, mechanical device with continuously variable ratio).

This need for speed adaptation is also found in the drive train of certain accessories.

To ensure such adaptation, solutions for electric transmission of power can be exploited as an alternative to the mechanical arrangements: in a first step, the motive mechanical power is transformed to electric power by an electric generating machine, then is it reconverted to mechanical form by an electric motor. The electronic control units of the generator and of the motor then permit total speed decoupling.

It is to be noted that such a continuous electric variator does not necessarily transmit all of the mechanical power to be transmitted: it can be used to provide the necessary flexibility to mechanical transmission devices, as is the case, for example, in the multi-mode transmission system described in French Patent Application 2823281.

It will also be noted that there can be added to this electric transmission an electric storage device (accumulator, etc.), which opens up further opportunities for managing the energy flows. In the case of a motor vehicle transmission, for example, such management permits, in particular, savings in fuel consumption or improvements in performance, such as: regenerative braking, greater latitude of choice of the operating points of the motive source depending on efficiency criteria, temporary injections of boost power, startup of the internal combustion engine. In this case, the motive electric machine also makes it possible to maintain driving capacity during the phases in which the mechanical motive source is not available.

On the other hand, however, the electric transmission suffers from some disadvantages which limit its practical applications, especially:
space requirement and mass of the electric machines and of the associated mechanical integration,
efficiency, which results from the product of the efficiencies in the two cascaded energy conversion steps.

U.S. Pat. No. 6,373,160 describes an electric machine that can be used to transmit mechanical power between two shafts. The stator present in the air gap comprises a single external winding and a single internal winding between the two rotors.

The purpose of the present invention is to contribute substantial progress to the foregoing aspects, by virtue of arrangements that permit high-level integration of the machines as well as a large reduction of both Joule losses and losses in the electronic unit.

According to the invention, the electric transmission, especially for a motor vehicle, comprising two electric machines, the shaft of one of the electric machines being connected to a motive power source, this machine converting the mechanical energy to electrical energy, the other electric machine converting the electrical energy to mechanical energy, its shaft being connected to the element to be driven, the rotors of both machines being disposed concentrically or axially relative to one another, these two rotors cooperating with stators whose windings are disposed inside the space defined by the two rotors, is characterized in that the said windings comprise a plurality of annular windings juxtaposed in the said space, these windings being supplied by alternating currents shifted in phase relative to one another.

Compared with an electric transmission comprising two separate machines, the arrangements according to the invention contribute gains in compactness associated with the high-level integration as well as efficiency gains derived in particular from a reduction of the Joule losses by virtue of the favorable layout of the windings and, in the case of composite current control, because these windings become one common winding and also losses in the power electronics are reduced. The present invention provides for disposing a plurality of annular windings juxtaposed in the space between two rotors. This arrangement makes it possible to supply the windings by alternating currents shifted in phase relative to one another.

This transmission can also be used as a double traction engine having two independent drive shafts that ensure the “differential” function electrically:

According to other features of the electric transmission according to the invention:
one of the rotors is mounted to rotate on the shaft of the other rotor, and it drives the rotation of a shaft axially offset from the shaft of the first rotor;
the stator windings are disposed in the annular space between the two rotors and comprise a first annular layer of windings cooperating with one of the rotors, surrounding a second annular layer of windings cooperating with the other rotor, the two annular layers of windings being connected mechanically to one another;
each winding is disposed in a core of ferromagnetic material covered laterally on each side by an end plate of ferromagnetic material provided opposite the rotor with claws engaged between the claws of the end plate situated on the other side of the core;
as an alternative, each winding is disposed in a core of ferromagnetic material covered laterally on each side by an end plate of ferromagnetic material provided opposite the rotor with teeth pointing toward the rotor;
each rotor can be provided at its periphery with a cylindrical yoke of ferromagnetic material, supporting a series of magnets on its internal face pointing toward the stator windings;
as an alternative, each rotor is provided on its periphery with a series of ferromagnetic stubs extending opposite the stator windings;
the annular space between the two rotors can be provided with a single series of juxtaposed windings;
according to one alternative, the peripheral surfaces of the two rotors are adjacent to one another and the annular windings of the stator are situated opposite the internal surface of the rotor that is situated inside the other rotor;
the transmission can comprise a stator composed of a plurality of juxtaposed pancake coils, each provided with an annular winding and supporting on its periphery ferromagnetic claws engaged between the claws of the periphery of the neighboring pancake coil, an intermediate rotor forming an asynchronous cage provided with conductive bars parallel to the rotor axis and a series of ferromagnetic stubs situated between the bars, this intermediate rotor being surrounded by an external rotor provided with conductive bars composed of segments parallel to the rotor axis and offset angularly relative to one another and a series of ferromagnetic stubs situated between the bars.

Other purposes, characteristics and advantages of the present invention will become apparent by way of example by reading the description hereinafter and examining the attached drawings, wherein:

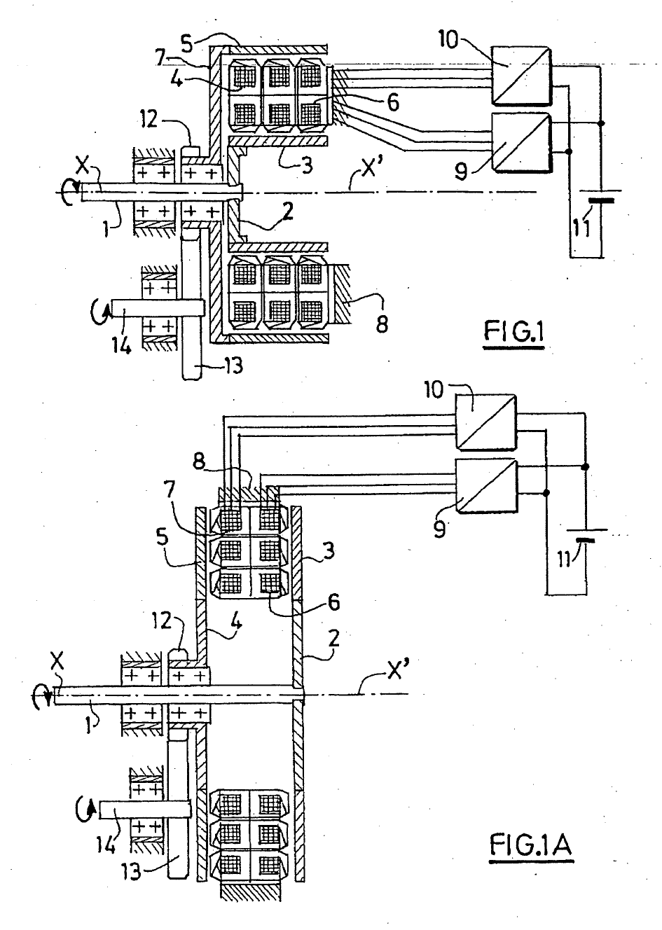

FIG. 1 is an elementary diagram of an electric transmission in which the two machines have annular armatures integrated in adjacent spaces,

FIG. 1A is a diagram analogous to FIG. 1, showing an axial arrangement of the two machines,

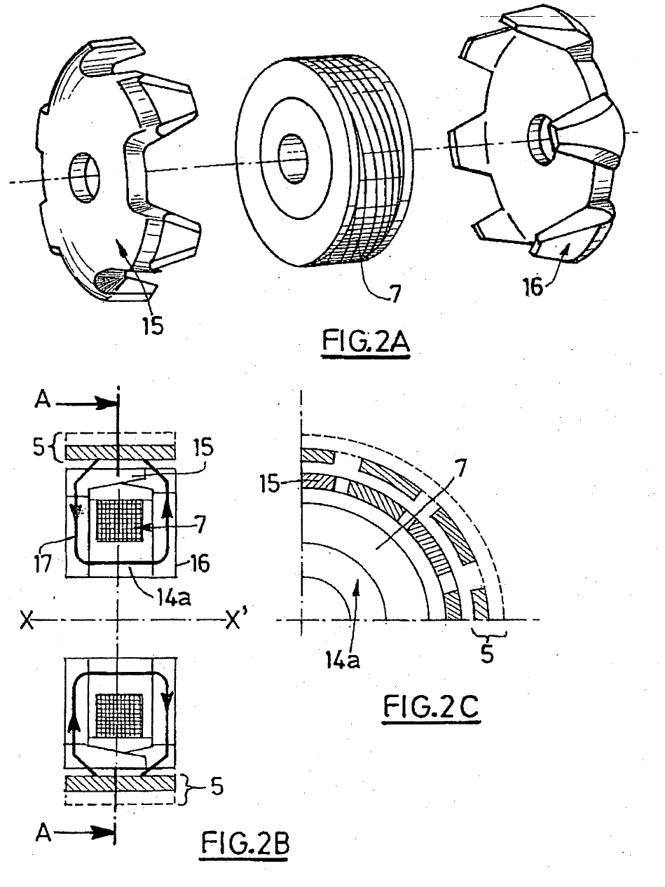

FIG. 2A is an exploded view of a magnetic circuit arrangement with claws around a centralized annular winding,

FIG. 2B is a view in section in a plane passing through the longitudinal axis of a magnetic circuit with claws with centralized annular winding; a rotor with surface magnets is illustrated in order to assist in understanding,

FIG. 2C is a quarter section in the direction AA of FIG. 2B,

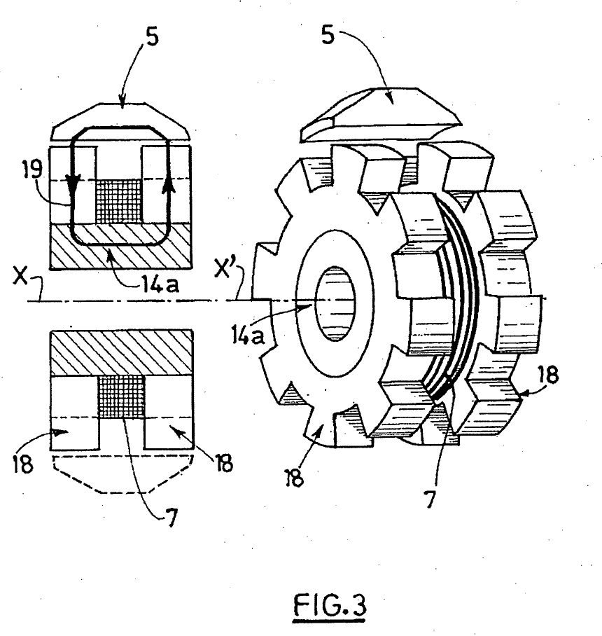

FIG. 3 is a view of a magnetic circuit device with centralized annular winding in a variable reluctance configuration with transverse flux loop to the rotor,

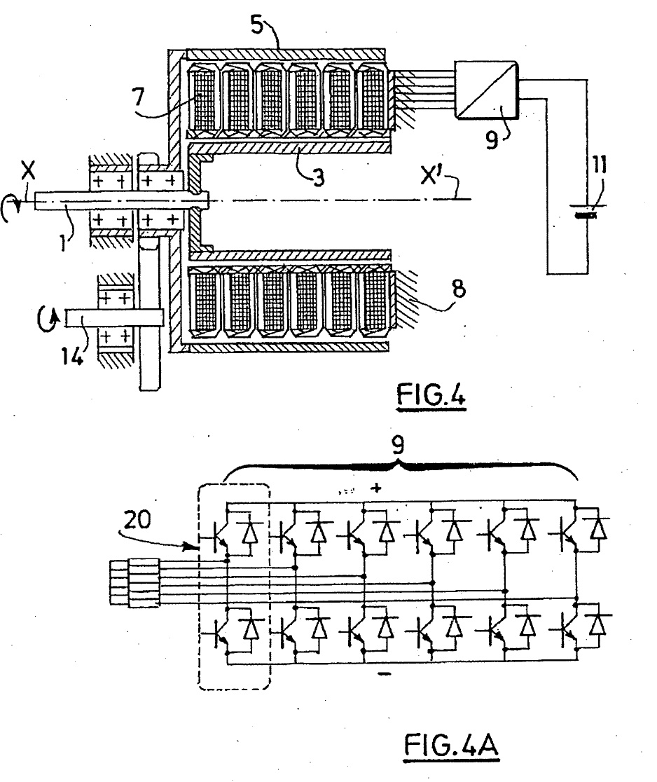

FIG. 4 is a device according to the invention wherein the windings of the two armatures become one common winding,

FIG. 4a is the electronic schematic of an inverter,

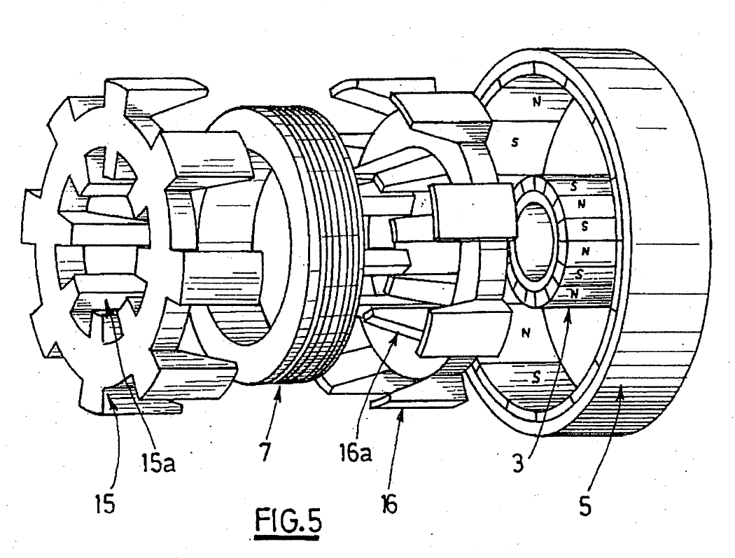

FIG. 5 is an exploded view of a winding according to the arrangement of FIG. 4 with its double system of claws,

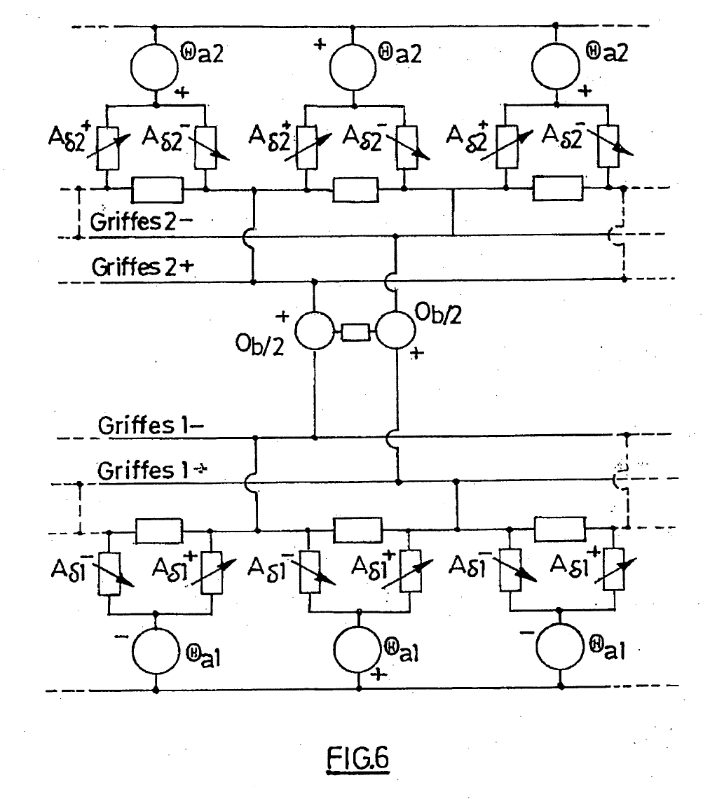

FIG. 6 is an equivalent diagram of the magnetic circuit of a practical example with composite currents and traversing flux,

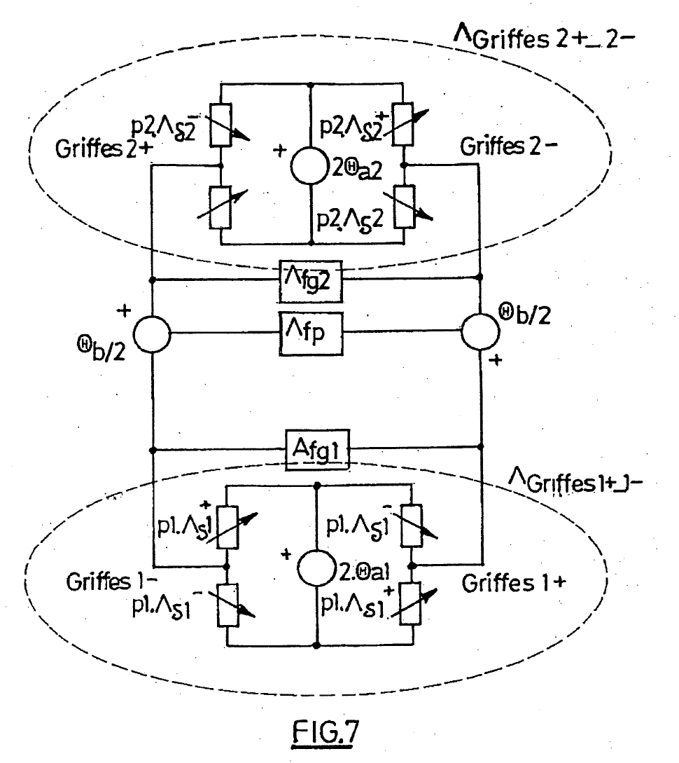

FIG. 7 is a globalized equivalent diagram of FIG. 6,

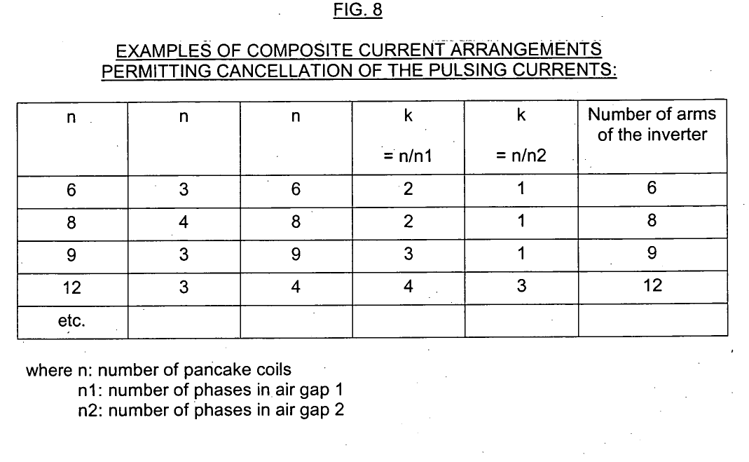

FIG. 8 shows examples of arrangements of composite currents permitting cancellation of pulsing currents,

FIG. 9 shows an example of adaptation to the invention of an asynchronous cage illustrated in perspective on the internal rotor; a nonmagnetic space is provided between the magnetic circuits associated with each pancake coil,

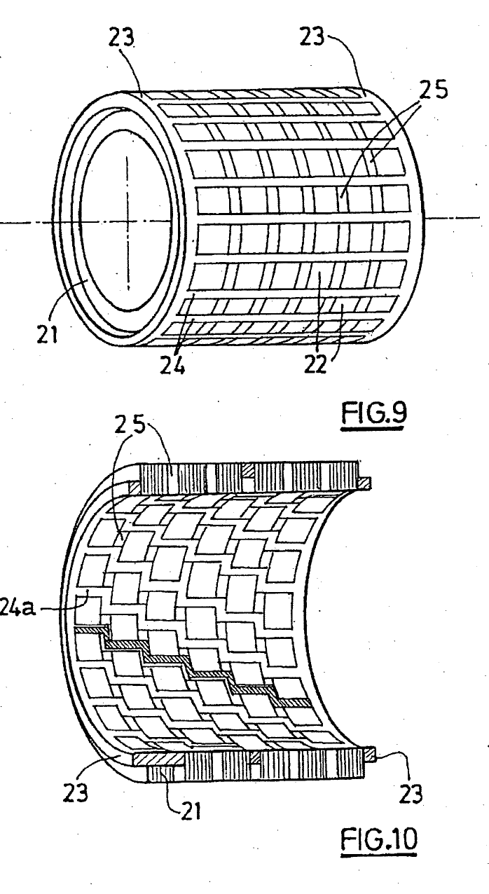

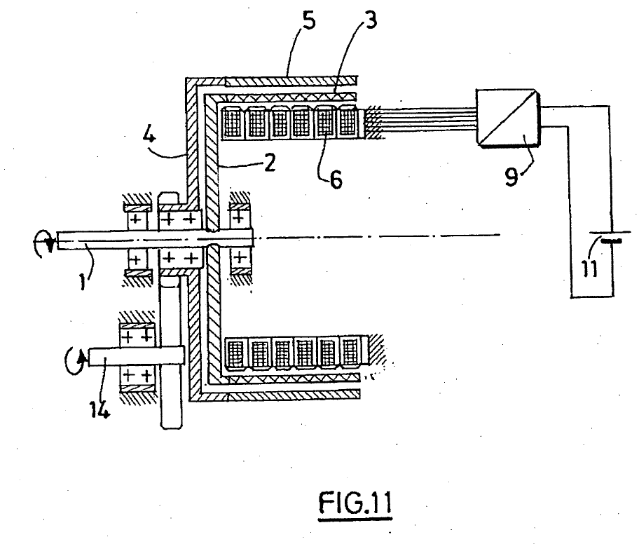

FIG. 10 shows another example of adaptation to the invention of an asynchronous cage; in this case the perspective view shows only half of the external rotor; the conductive bars carry segments that are offset angularly to achieve the desired phase shift,

FIG. 11 is an elementary diagram of a device according to the invention with traversing-flux intermediate rotor and composite current control,

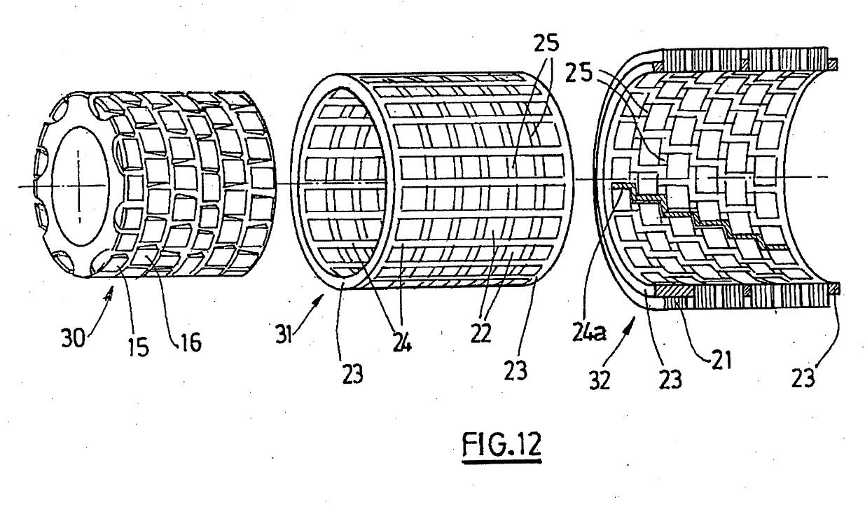

FIG. 12 is an exploded view according to the principle of FIG. 11 of a device with traversing-flux intermediate rotor and composite current control in an asynchronous cage configuration.

FIG. 1 represents an electric transmission provided with an input shaft 1 connected to the engine, integral with a disk 2 supporting a magnetic element 3 of cylindrical shape centered on axis X-X′ of shaft 1.

Around shaft 1, adjacent to first disk 2, there is mounted a second disk 4 that can rotate freely relative to the said shaft. This second disk 4 supports a magnetic element 5 of cylindrical shape, annularly surrounding first magnetic element 3.

In the annular space between the two magnetic elements 3 and 5 there are disposed a first series of three annular windings 6 adjacent to first element 3 and surrounded by a second series of three annular windings 7 adjacent to second element 5. Annular windings 6 and 7 are integral with a fixed part 8. Windings 6 are connected to an electronic unit 9. Windings 7 are connected to an electronic unit 10. Electronic units 9 and 10 are supplied by a battery 11.

Furthermore, disk 4 is connected by pinions 12, 13 to an output shaft 14 extending parallel to input shaft 1.

According to the invention, the armatures of the two electric machines have, at the stator, magnetic circuits organized around annular windings and united in adjacent spaces, as indicated in section by the elementary diagram of FIG. 1. In this FIG. 1 there are represented in section three annular windings and their magnetic circuits placed side-by-side and centered on the common axis of revolution X-X′.

As is evident in FIG. 1, the air gaps associated respectively with the armatures are cylindrical, meaning that they are traversed radially by the magnetic fluxes. Transposition of the invention to axial flux is possible, however, as shown by the example of FIG. 1A: therein there are again shown the two machines with their adjacent stators and annular windings 6, 7, but their magnetic circuits open onto plane air gaps; the rotors, which are positioned on both sides of the stator assembly, assume the shape of disks 2, 4; the bearings permit the already described rotational movements, and also maintain the rotating parts axially against the electromagnetic forces of attraction generated in the air gaps.

According to a first embodiment, magnetic coupling at its air gap of one of these windings can be achieved by a double system of claws, as represented in exploded view in FIG. 2A. The multi-pole flux collected in the air gap is therefore globalized in the core (or yoke) on which the winding is wound.

FIG. 2B shows a schematic view in section in a plane passing through the longitudinal axis; to facilitate understanding, the flux circulation in the stator is indicated and there is disposed, opposite this stator, a rotor example composed of a yoke having the shape of a ferromagnetic ring supporting radially magnetized surface magnets having alternate polarities.

FIG. 2C supplements this diagram by a quarter view in section AA of FIG. 2B along the longitudinal axis.

In these FIGS. 2A, 2B, 2C, numeral 7 denotes an annular winding. Numeral 14a denotes the ferromagnetic core or yoke of winding 7. Numeral 5 denotes the rotor, shown here with surface magnets forming a flux loop with a ferromagnetic yoke. Numerals 15 and 16 denote the double system of claws.

In FIG. 2B, numeral 17 shows the line of circulation of the magnetic flux between rotor 5, first claws 15, core 14a of winding 7 and second claws 16.

It is understood that, by adapting the proportions given in these figures, and in particular by enlarging the central bore in the core, it is possible in this way to constitute one of the magnetic circuits shown opposite air gap 2 (external) in FIG. 1.

In the same way, by inverting the radial arrangement relative to the rotor and stator, it is possible to realize one of the magnetic circuits shown opposite air gap 1 (between rotor 3 and the windings) in FIG. 1: the systems of claws then ensure coupling with an internal air gap. Once the proportions have been adapted, this second assembly can be lodged inside the central bore of the first, with identical longitudinal thickness.

The term “pancake coil” will be used here to denote the assembly formed in this way along an axial portion of the machine and comprising for each armature an annular winding and the associated magnetic circuit, as well as the two facing rotor parts. FIG. 1 therefore represents a machine composed of three pancake coils.

The active parts of the rotors can be made in very many ways in accordance with the usual principles for construction of electric machines: arrangements with surface magnets, inserted magnets, embedded magnets, asynchronous cage, synchronous reluctant saliency, or even combinations of these principles. However, two features are to be noted: one relates to nonmagnetic spacing, which may be useful to establish between the parts of the rotor magnetic circuits of each successive pancake coil in order to avoid undesirable coupling between neighboring pancake coils; the other concerns the precautions to be taken in the asynchronous arrangements in order to avoid flows of intermediate currents between the short-circuit rings. These two aspects will be explained farther on in the text.

It is to be observed that the magnetic circuits in both the stators and rotors are traveled by alternating fluxes: to avoid the development of eddy currents in their bodies, it is advisable to choose electrically resistive ferromagnetic materials. The traditional solution of “lamination” by juxtaposition of mutually insulated magnetic sheets may be suitable in the magnetic circuit portions where the field lines remain substantially in the same plane; in the stator, however, the three-dimensional character of the flux circulation encourages the use of composite magnetic materials (“iron powders”, “soft magnetic composites”), such as those proposed, for example, by the Hoganas Co. in Sweden or Quebec Metal Powder in Canada.

To facilitate manufacture, especially in the case of structures having large dimensions, the parts made of “iron powder” (soft magnetic composite: SMC) can be sectored into smaller elements, which are assembled together. The good tolerances obtained in molding SMC parts generally avoids the need to repeat machining.

In the arrangements provided with magnets, these must also be electrically resistive or else also fragmented into insulated elements.

The general functioning of each machine is based on multi-phase construction of forces: in a given air gap i, the active parts of the stator and of the facing rotor are successively offset by an angle of 2π/n/pᵢ in relative value, where pᵢ represents the number of pole pairs in this air gap, or in other words the number of claw pairs, and n represents the number of phases. Thus the supply of the windings of an armature by an electronic inverter with an n-phase system of currents makes it possible to obtain a substantially constant global resultant torque in this air gap. Of course, the time spacing of these currents must be controlled on the basis of position information (case of synchronous machines) or possibly of speed information (asynchronous case), in accordance with the known techniques.

The relative angular offset between pancake coils can be obtained partly or totally by acting on either the successive angular position of the systems of claws or on that of the active parts of the rotor.

The number of pancake coils must be a multiple of the number of phases; in the diagram of FIG. 1, for example, each pancake coil corresponds to one phase: the system is three-phase.

According to a second embodiment, coupling of a winding with its air gap is achieved by a variable-reluctance homopolar arrangement with transverse flux loop to the rotor. This arrangement is illustrated in principle in FIG. 3. The winding remains annular, but coupling in the air gap takes place no longer via the claws but via a double toothing. The teeth of each toothing are identical in number and are opposite one another. Facing them, the rotor supports a number of ferromagnetic stubs corresponding to these pairs of teeth. (NB: to simplify the illustration, a single stub of this type is shown in FIG. 3). When they are opposite the teeth, the stubs permit a transverse magnetic link between them: the maximum permeance associated with the winding is maximal; in contrast, when they are opposite the slots, the permeance is minimal. It will be understood that a reluctant torque can be created with this arrangement.

In FIG. 3, numeral 7 denotes an annular winding. Numeral 14a denotes the ferromagnetic core or yoke of winding 7. Numeral 5 denotes the rotor, which in this example is composed of rotating ferromagnetic stubs.

Numeral 18 denotes two toothed ferromagnetic plates disposed on both sides of winding 7. Numeral 19 denotes the circulation of the magnetic flux between rotor 5, first plate 18, yoke 14a and second plate 18.

As in the foregoing with systems of claws, a double machine composed of successive pancake coils can be constructed in this way. With the already mentioned angular offsets between pancake coils and the supply of each armature by n-phase inverter, useful resultant torques in each air gap are obtained as desired.

The comments about choice of materials of the magnetic circuits remain valid here; FIG. 3 suggests a construction having an “iron powder” core and teeth composed of assemblies of sheets. It is also possible to use an arrangement in which the sheet packets form successive arches in a fan configuration. The magnetic stubs can be made of sheets or of iron powder. Their assembly has not been illustrated: they can be joined together in an electrically resistive over-molded material that will ensure the mechanical connection to the rotor.

As indicated hereinabove, and in general for the arrangements according to the invention, it is advisable to allow for parasitic magnetic couplings by leaks between adjacent pancake coils. A first means of limiting this coupling consists in disposing a nonmagnetic space between the successive stators of neighboring pancake coils. This space can be advantageously used, for example to introduce a cooling circuit. Another means, which may be better suited to achieving good axial compactness, consists in introducing this nonmagnetic space between the successive magnetic parts of the rotors, at the boundaries between pancake coils.

The Joule losses of these structures are reduced particularly well by virtue of several beneficial factors, especially: circular geometry of the windings, which considerably shortens the copper length—it is the magnetic circuit that is deformed; a compromise between “slot cross section” and “cross section for passage of the flux in the core” that is less constraining than in the usual 2-dimensional structures for flux circulation; higher coefficients of filling the slot with copper, with the bonus of simplicity of manufacture of windings. This low level of Joule losses is beneficial in terms of efficiency and heating effects.

Another arrangement according to the invention is illustrated in principle in FIG. 4. The two armatures are inspired by the circular winding arrangement already illustrated in FIG. 1. In contrast to configuration 1, however, there is now only one winding 7 per pancake coil instead of two: this winding 7 is common to both armatures; the magnetic yokes that in the foregoing separated the windings of FIG. 1 have disappeared; the fixed magnetic circuits of the two armatures have become one common circuit; the primary flux collected in air gap 1 (between rotor 3 and the windings) is therefore composed of that issuing from air gap 2 (between rotor 5 and the windings). The magnetic circuit of the fixed parts of the armatures will be said to be of “traversing flux” type.

Where two inverters were supplying each of the multi-phase windings specific to each armature in the arrangements described hereinabove, now only a single common inverter 9 is used: it will supply the windings by multi-phase currents composed of two superposed components.

FIG. 4A shows the schematic of an inverter 9. In this figure, numeral 20 denotes a bridge arm.

Hereinafter this principle of current superposition will be described by the term “composite current control”. Controls of this type have already been described under other conditions in known patents, such as U.S. Pat. No. 6,373,160, U.S. Pat. No. 6,049,152 and EP 1089425. They will be presented more explicitly later in the scope of the invention.

As will be seen later, the choice of an arrangement with 6 pancake coils in FIG. 4 corresponds to one of the options for exploiting composite current control in order to be free of parasitic torque undulations.

The stator heights of FIG. 1 have been retained in their entirety to demonstrate the increase in cross section that is possible with a single winding compared with each of the prior art windings.

Electrical energy storage is still optional.

To facilitate understanding, FIG. 5 shows an exploded view indicative of a winding 7 and of the double system of claws 15, 15a; 16, 16a associated therewith; the assembly is positioned opposite the two rotors 3, 5.

Rotors 3, 5 have been represented schematically with surface magnets in the two air gaps; each of these groups of magnets is disposed on a ferromagnetic ring (internal and external respectively), which ensures the flux loop. This hypothesis, convenient for visualization and reasoning, will be used as the basis for developing the presentation of composite current control hereinafter, but as has already been mentioned hereinabove, numerous other embodiments are possible, and may even be preferable considering the constraint of demagnetization resistance of the magnets (inserted magnets, embedded magnets, asynchronous, reluctance, for example with transverse flux loop as in FIG. 3, and combinations).

The functioning of an arrangement of this type supplied by composite currents will now be described.

The numbers of claws of each air gap correspond to the numbers of magnets facing one another; thus there are p1 and p2 pole pairs respectively in each air gap.

The number n of pancake coils is chosen to be a common multiple of n1 and n2:

$${Ω}_{1} = \frac{ⅆ {α}_{1}}{ⅆ t} and {Ω}_{2} = \frac{ⅆ {α}_{2}}{ⅆ t}$$

In air gap 1, the successive arrangement of pancake coils has an angular phase shift of 2π/(n1.p1); this phase shift can be obtained either by acting on the angular setting of the group of magnets associated with this pancake coil in air gap 1, or on the corresponding group of claws of the rotor of the motive source. Relative to air gap 1, therefore, the system electrically has n1 phases.

Similarly, in air gap 2, the successive arrangement of pancake coils has an angular phase shift of 2π/(n2.p2); this phase shift can be obtained either by acting on the angular spacing of the group of magnets associated with this pancake coil in air gap 2, or on the corresponding group of fixed claws. Relative to air gap 2, therefore, the system electrically has n2 phases.

α1 is the relative angular position of the rotor associated with air gap 1.

α2 is the angular position of the rotor associated with air gap 2.

Thus, if Ω₁ and Ω₂ denote the respective speeds of the rotors:

$$\{ \begin{matrix}n = k 1 \cdot n 1 & \\ n = k 2 \cdot n 2 & where k 1 and k 2 are integers .\end{matrix}$$

It will be noted that ω₁=p₁·Ω₁ and ω₂=p₂·ω₂ respectively are the electric pulsations associated with the 2 air gaps.

Θa1, Θa2 and Θb respectively will be the magnetic potentials of the magnets of air gap 1, of air gap 2 and of the coil (or, in other words, its ampere turns).

A single inverter (see FIG. 4) replaces the two inverters necessary hereinabove for the arrangements with separate armatures, such as that of FIG. 1. This single inverter is provided with a number of arms corresponding to a common multiple of n1 and n2, preferably the least common multiple. This number of arms corresponds to the number of pancake coils, unless each multi-phase system has several groups of identical phases: in this case, the windings of identical setting can be connected in parallel or in series.

According to the known principle of chopping by switching of electronic components, and by exploiting the angular information α1, the inverter can therefore generate a multi-phase current system of pulsation ω1 in each of the k1 groups of pancake coils with n1 phases; within a group, each current is successively phase-shifted by 2π/n1, and the sum of the currents is zero.

In the same way, the inverter can also generate a multi-phase current system of pulsation ω2 in each of the k2 groups of pancake coils with n2 phases; within a group, each current is successively phase-shifted by 2π/n2, and the sum of the currents is zero.

The two multi-phase systems can be superposed by summing the inputs, and a pancake coil i will be traveled by currents that endow it with a magnetic potential:

$${Θ}_{b\_i} = {Θ}_{b 1} \cdot sin ( {p}_{1} \cdot {α}_{1} + {φ}_{1} - \frac{2 Π}{{n}_{1}} \cdot i ) + {Θ}_{b 2} \cdot sin ( {p}_{2} \cdot {α}_{2} + {φ}_{2} - \frac{2 Π}{{n}_{2}} \cdot i )$$

or else, by replacing n1 and n2 by their values as a function of n:

$${Θ}_{b\_i} = {Θ}_{b 1} \cdot sin ( {p}_{1} \cdot {α}_{1} + {φ}_{1} - \frac{2 Π}{n} \cdot {k}_{1} \cdot i ) + {Θ}_{b 2} \cdot sin ( {p}_{2} \cdot {α}_{2} + {φ}_{2} - \frac{2 Π}{n} \cdot {k}_{2} \cdot i )$$

where Θ_{b1} and Θ_{b2}, φ₁ and φ₂ are amplitudes and phasings that can be adjusted by the electronic control unit.

The point of interest now is the functioning of the magnetic circuit.

FIG. 6 shows an equivalent diagram of the magnetic circuit defined in this way in a pancake coil. The ferromagnetic parts have been idealized as perfect flux conductors (infinite permeance). In addition, the magnetic circuit is considered to be linear. The permeances represented in gray form symbolize the leakage paths (leaks between claws, leaks distributed over the winding).

This diagram is globalized in FIG. 7.

The magnetic coupling of the magnets with the claws is described by a set of permeances Λδ+1 or 2 and Λδ−1 or 2, variable with position and which integrate the permeance of the air gap and the internal permeance of the magnet.

It will be assumed that these variations can be expressed by:

$${Λ}_{δ\_ 1 or 2}^{+} = \frac{{Λ}_{δ\_ 1 or 2 max}}{2} \cdot cos ( {p}_{1 or 2} \cdot {α}_{1 or 2} ) + \frac{{Λ}_{δ\_ 1 or 2 max}}{2}$$

$${Λ}_{δ\_ 1 or 2}^{-} = \frac{- {Λ}_{δ\_ 1 or 2 max}}{2} \cdot cos ( {p}_{1 or 2} \cdot {α}_{1 or 2} ) + \frac{{Λ}_{δ\_ 1 or 2 max}}{2}$$

Under these conditions, the electromagnetic torque of a pancake coil in air gap 1 is written:

$${C}_{δ1} = \frac{1}{2} \cdot \frac{ⅆ {Λ}_{a 1 a 1}}{ⅆ {α}_{1}} + \frac{1}{2} \cdot \frac{ⅆ {Λ}_{a 2 a 2}}{ⅆ {α}_{1}} + \frac{1}{2} \cdot \frac{ⅆ {Λ}_{b b}}{ⅆ {α}_{1}} \cdot {Θ}_{b}^{2} + \frac{ⅆ {Λ}_{a 1 a 2}}{ⅆ {α}_{1}} \cdot 2 {Θ}_{a 1} \cdot 2 {Θ}_{a 2} + \frac{ⅆ {Λ}_{a 1 b}}{ⅆ {α}_{1}} \cdot 2 {Θ}_{a 1} \cdot {Θ}_{b} + \frac{ⅆ {Λ}_{a 2 b}}{ⅆ {α}_{1}} \cdot 2 {Θ}_{a 2} \cdot {Θ}_{b}$$

and in air gap 2:

$${C}_{δ2} = \frac{1}{2} \cdot \frac{ⅆ {Λ}_{a 1 a 1}}{ⅆ {α}_{2}} + \frac{1}{2} \cdot \frac{ⅆ {Λ}_{a 2 a 2}}{ⅆ {α}_{2}} + \frac{1}{2} \cdot \frac{ⅆ {Λ}_{b b}}{ⅆ {α}_{2}} \cdot {Θ}_{b}^{2} + \frac{ⅆ {Λ}_{a 1 a 2}}{ⅆ {α}_{2}} \cdot 2 {Θ}_{a 1} \cdot 2 {Θ}_{a 2} + \frac{ⅆ {Λ}_{a 1 b}}{ⅆ {α}_{2}} \cdot 2 {Θ}_{a 1} \cdot {Θ}_{b} + \frac{ⅆ {Λ}_{a 2 b}}{ⅆ {α}_{2}} \cdot 2 {Θ}_{a 2} \cdot {Θ}_{b}$$

where
Λa1b is the mutual permeance between magnets a1 and coil b, etc.

The terms with the coefficient ½ correspond to the reluctant components.

Each of the terms of these expressions for the torques will now be evaluated.

Preliminary remark: since the magnets are “turned off” (short circuit), the groups of permeances comprising air gaps and magnets within the circles of FIG. 7 respectively have an equivalent value of:

$$\begin{matrix}{Λ}_{Claws 1 + \_ 1 -} = ( \begin{matrix}{p}_{1} \cdot {Λ}_{δ1 +} + \\ {p}_{1} \cdot {Λ}_{δ1 -}\end{matrix} ) \_in \_series \_with \_ ( \begin{matrix}{p}_{1} \cdot {Λ}_{δ1 -} + \\ {p}_{1} \cdot {Λ}_{δ1 +}\end{matrix} ) \\ = \frac{{p}_{1} \cdot {Λ}_{δ1 +} + {p}_{1} \cdot {Λ}_{δ1 -}}{2} \\ = \frac{{p}_{1} \cdot {Λ}_{δ1max}}{2}\end{matrix}$$

$${Λ}_{Claws 2 + \_ 2 -} = \frac{{p}_{2} \cdot {Λ}_{δ2max}}{2}$$

or in other words a constant value.

$$\begin{matrix}Evaluation of the reluctant torques in \\ \frac{ⅆ {Λ}_{a 1 a 1}}{ⅆ {α}_{2}} ; \frac{ⅆ {Λ}_{a 2 a 2}}{ⅆ {α}_{1}} ; \\ \frac{ⅆ {Λ}_{bb}}{ⅆ {α}_{1}} and \frac{ⅆ {Λ}_{bb}}{ⅆ {α}_{2}}\end{matrix}$$

It results from the preliminary remark that:

$$\frac{ⅆ {Λ}_{a 1 a 1}}{ⅆ {α}_{2}} = \frac{ⅆ {Λ}_{a 2 a 2}}{ⅆ {α}_{1}} = \frac{ⅆ {Λ}_{bb}}{ⅆ {α}_{1}} = \frac{ⅆ {Λ}_{bb}}{ⅆ {α}_{2}} = 0$$

=>these reluctant torques are zero in each pancake coil.

$$\begin{matrix} \\ Evaluation of the reluctant torques in \frac{ⅆ {Λ}_{a 1 a 1}}{ⅆ {α}_{1}} and \frac{ⅆ {Λ}_{a 2 a 2}}{ⅆ {α}_{2}} \\ \end{matrix}$$

The calculation of Λₐ₁ₐ₁ leads to an equation of the type:
Λ_{α1α1}=−Λ_{α1α1max}·cos²(p₁·α₁)+constant
where:

$${Λ}_{a 1 a 1 max} = \frac{{Λ}_{Claws 1 + \_ 1 -}}{1 + \frac{{Λ}_{f g 1} + {Λ}_{Claws 2 + \_ 2 -} + {Λ}_{f g 2} + {Λ}_{f p}}{{Λ}_{Claws 1 + \_ 1 -}}} , \\ and so$$

$${Λ}_{a 1 a 1 max} < {Λ}_{Claws 1 + \_ 1 -}$$

In a pancake coil, therefore, there exists a reluctant torque associated with the magnets in air gap 1:

$$\begin{matrix}\frac{1}{2} \cdot \frac{ⅆ {Λ}_{a 1 a 1}}{ⅆ {α}_{1}} \cdot {( 2 {Θ}_{a} )}^{2} = {p}_{1} \cdot {Λ}_{a 1 a 1 max} \cdot sin ( {p}_{1} {α}_{1} ) \cdot cos ( {p}_{1} {α}_{1} ) \cdot {( 2 {Θ}_{a} )}^{2} \\ = \frac{{p}_{1} \cdot {Λ}_{a 1 a 1 max}}{2} \cdot sin ( 2 {p}_{1} {α}_{1} ) \cdot {( 2 {Θ}_{a} )}^{2}\end{matrix}$$

This torque in a pancake coil is pulsing at two times the synchronous frequency of air gap 1; it is proportional to the number p1 of poles; the leaks tend to be attenuated.

Its multi-phase composition over the set of pancake coils therefore gives a zero resultant; (except for the special case in which n=2, which in fact occurs with a single phase, with two windings in phase opposition).

Similarly, a pulsing reluctant torque associated with magnets 2 exists in each pancake coil in air gap 2; it is proportional to the number p2 of poles, and the leaks tend to be attenuated. Once again, the multi-phase resultant thereof is zero except for the case of n=2.

$$\begin{matrix}Evaluation of the interaction \\ torques between magnets of the \\ two air gaps ( terms in \frac{ⅆ {Λ}_{a 1 a 2}}{ⅆ {α}_{1}} and \frac{ⅆ {Λ}_{a 1 a 2}}{ⅆ {α}_{2}} )\end{matrix}$$

The calculation of Λa1a2 in pancake coil i leads to:

$${Λ}_{a 1 a 2} = {Λ}_{a 1 a 2 max} \cdot cos ( {p}_{1} {α}_{1} - \frac{2 Π}{n} \cdot {k}_{1} \cdot i ) \cdot cos ( {p}_{2} \cdot {α}_{2} - \frac{2 Π}{n} \cdot {k}_{2} \cdot i )$$

where, when the leakage permeances can be neglected:

$${Λ}_{a 1 a 2 max} = \frac{1}{\frac{1}{{Λ}_{Claws 1 + \_ 1 -}} + \frac{1}{{Λ}_{Claws 2 + \_ 2 -}}}$$

The leakage permeances lead in practice to a reduction of this term, the complete equation being:

$${Λ}_{a 1 a 2 max} = \frac{{Λ}_{Claws 2 + \_ 2 -}}{{Λ}_{Claws 2 + \_ 2 -} + {Λ}_{f g 2} + {Λ}_{f p}} \cdot \frac{1}{\frac{1}{{Λ}_{Claws 1 + \_ 1 -}} \cdot ( \frac{{Λ}_{f g 1}}{\begin{matrix}{Λ}_{Claws 2 + \_ 2 -} + \\ {Λ}_{f g 2} + {Λ}_{f p}\end{matrix}} + 1 ) + \frac{1}{{Λ}_{Claws 2 + \_ 2 -} + {Λ}_{f g 2} + {Λ}_{f p}}}$$

Thus, in the air gap 1 of pancake coil i, the torque related to the interaction between groups of magnets 1 and 2 is:

$$\frac{ⅆ {Λ}_{a 1 a 2}}{ⅆ {α}_{1}} \cdot 2 {Θ}_{a 1} \cdot 2 {Θ}_{a 2} = - {p}_{1} \cdot {Λ}_{a 1 a 2 max} \cdot 2 {Θ}_{a 1} \cdot 2 {Θ}_{a 2} \cdot sin ( {p}_{1} \cdot {α}_{1} - \frac{2 Π}{n} \cdot {k}_{1} \cdot i ) \cdot cos ( {p}_{2} \cdot {α}_{2} - \frac{2 Π}{n} \cdot {k}_{2} \cdot i )$$

$$or else$$

$$\frac{ⅆ {Λ}_{a 1 a 2}}{ⅆ {α}_{1}} \cdot 2 {Θ}_{a 1} \cdot 2 {Θ}_{a 2} = - \frac{{p}_{1} \cdot {Λ}_{a 1 a 2 max}}{2} \cdot 2 {Θ}_{a 1} \cdot 2 {Θ}_{a 2} \cdot ( sin ( {p}_{1} \cdot {α}_{1} + {p}_{2} \cdot {α}_{2} - \frac{2 Π}{n} \cdot ( {k}_{1} + {k}_{2} ) \cdot i ) + sin ( {p}_{1} \cdot {α}_{1} - {p}_{2} \cdot {α}_{2} - \frac{2 Π}{n} \cdot ( {k}_{1} - {k}_{2} ) \cdot i ) )$$

Consequently, the pancake coil in question is subjected in air gap 1 to a pulsing torque having 2 components: one is the pulsation ω1+ω2 and the other is |ω1−ω2|.

However, with the exception of certain special cases, such as that in which the 2 air gaps have the same number of phases: n1=n2 (see appendix by way of indication), the multi-phase resultants at ω1+ω2 and |107 1−ω2| are zero. This is the case in particular for the examples of the table of FIG. 8.

By symmetry, there exists in air gap 2 of a pancake coil a pulsing torque with one component at ω1+ω2 and the other at |ω1−ω2|. Under the same conditions of number of phases as in the foregoing, the multi-phase resultants also cancel out in this air gap 2.

$$\begin{matrix}Evaluation of the interaction \\ betw een magnets and coil \\ ( terms in \frac{ⅆ {Λ}_{a 1 b}}{ⅆ {α}_{1}} and \frac{ⅆ {Λ}_{a 2 b}}{ⅆ {α}_{2}} ; \frac{ⅆ {Λ}_{a 1 b}}{ⅆ {α}_{2}} and \frac{ⅆ {Λ}_{a 2 b}}{ⅆ {α}_{1}} )\end{matrix}$$

The calculation of Λ_{a1b} leads to:

$${Λ}_{a 1 b} = {Λ}_{a 1 b max} \cdot cos ( {p}_{1} \cdot {α}_{1} - \frac{2 Π}{n} \cdot {k}_{1} \cdot i )$$

where, as a reminder:

$${Λ}_{a 1 b max} = \frac{1}{( \begin{matrix}\frac{1}{{Λ}_{Claws\_ 1 + \_ 1 -} + {Λ}_{f g 1}} + \\ \frac{1}{{Λ}_{Claws\_ 2 + \_ 2 -} + {Λ}_{f g 2}}\end{matrix} ) \cdot ( 1 + \frac{{Λ}_{f g 1}}{{Λ}_{Claws\_ 2 + \_ 2 -} + {Λ}_{f g 2}} )}$$

or else, if the leakage terms could be neglected:

$${Λ}_{a 1 b max} = \frac{1}{\frac{1}{{Λ}_{Claws\_ 1 + \_ 1 -}} + \frac{1}{{Λ}_{Claws\_ 2 + \_ 2 -}}}$$

Similarly, the calculation of Λ_{a2b} leads to

$${Λ}_{a 2 b} = {Λ}_{a 2 b max} \cdot cos ( {p}_{2} \cdot {α}_{2} - \frac{2 Π}{n} \cdot {k}_{2} \cdot i )$$

where again, if the leakage terms could be neglected, Λ_{α2bmax}=Λ_{α1bmax}.
It is therefore the terms in

$$\frac{ⅆ {Λ}_{a 1 b}}{ⅆ {α}_{1}} and \frac{ⅆ {Λ}_{a 2 b}}{ⅆ {α}_{2}}$$

that reflect the coupling of the coil
with the magnets; the terms in

$$\frac{ⅆ {Λ}_{a 1 b}}{ⅆ {α}_{2}} and \frac{ⅆ {Λ}_{a 2 b}}{ⅆ {α}_{1}}$$

do not produce any force.

To construct a useful mean torque in air gap 2 requires a current component with pulsation ω₂ synchronous with p₂α₂.

If it is therefore assumed that, by appropriate electronic control, there is generated in each pancake coil i:

$${Θ}_{b\_i} = {Θ}_{b 1} \cdot sin ( {p}_{1} \cdot {α}_{1} + {φ}_{1} - \frac{2 Π}{n} \cdot {k}_{1} \cdot i ) + {Θ}_{b 2} \cdot sin ( {p}_{2} \cdot {α}_{2} + {φ}_{2} - \frac{2 Π}{n} \cdot {k}_{2} \cdot i )$$

then there is developed in air gap 1 of pancake coil i the following torque:

$$\frac{ⅆ {Λ}_{a 1 b}}{ⅆ {α}_{1}} \cdot 2 {Θ}_{a 1} \cdot {Θ}_{b} = - {p}_{1} \cdot {Λ}_{a 1 b max} \cdot 2 {Θ}_{a 1} \cdot sin ( {p}_{1} {α}_{1} - \frac{2 Π}{n} \cdot {k}_{1} \cdot i ) \cdot ( {Θ}_{b 1} \cdot sin ( {p}_{1} \cdot {α}_{1} + {φ}_{1} - \frac{2 Π}{n} \cdot {k}_{1} \cdot i ) + {Θ}_{b 2} \cdot sin ( {p}_{2} \cdot {α}_{2} + {φ}_{2} - \frac{2 Π}{n} \cdot {k}_{2} \cdot i ) )$$

which can be rearranged to:

$$\frac{ⅆ {Λ}_{a 1 b}}{ⅆ {α}_{1}} \cdot 2 {Θ}_{a 1} \cdot {Θ}_{b} = - \frac{{p}_{1} \cdot {Λ}_{a 1 b max}}{2} \cdot 2 {Θ}_{a 1} \cdot ( {Θ}_{b 1} \cdot ( cos {φ}_{1} - cos ( 2 {p}_{1} {α}_{1} + {φ}_{1} - \frac{4 Π}{n} \cdot {k}_{1} \cdot i ) ) + {Θ}_{b 2} \cdot ( cos ( {p}_{1} {α}_{1} - {p}_{2} {α}_{2} + {φ}_{2} - \frac{2 Π}{n} \cdot ( {k}_{1} - {k}_{2} ) \cdot i ) - cos ( {p}_{1} {α}_{1} + {p}_{2} {α}_{2} + {φ}_{2} - \frac{2 Π}{n} \cdot ( {k}_{1} + {k}_{2} ) \cdot i ) )$$

Therefore, in air gap 1 of a pancake coil, the interaction between the coil and group 1 of magnets is reflected by a continuous useful component and 3 pulsing components of frequencies ω1, ω1+ω2 and |ω1−ω2| respectively.

The resultant at ω1 is zero for n1>2. The two other pulsing components also have zero resultants except for the special cases already mentioned; they are zero in particular for the examples of FIG. 8.
By symmetry, a similar result is obtained in air gap 2.

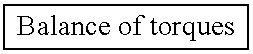

Finally, by taking into account the resultant of the torques under the conditions of cancellation of the pulsing components:

in air gap 1:

$${C}_{δ1} = \frac{n \cdot {p}_{1} \cdot {Λ}_{a 1 b max}}{2} \cdot 2 \cdot {Θ}_{a 1} {Θ}_{b 1} \cdot cos {φ}_{1}$$

$$in air gap 2 \text{:}$$

$${C}_{δ2} = \frac{n \cdot {p}_{2} \cdot {Λ}_{a 2 b max}}{2} \cdot 2 \cdot {Θ}_{a 2} {Θ}_{b 2} \cdot cos {φ}_{2}$$

The increase of torques with the number of poles, within the limit of increasing parasitic effects related to leaks, is a natural effect of globalized armature structures: an increase in the number of poles does not generate any constraint on the cross section of the winding.

Under established operating conditions, the torque of the first air gap is adjusted to balance that of the motive source by acting on Θb1·cos φ₁. The torque on the output rotor is then regulated by acting on the torque of the second air gap via Θb2·cos φ₂.

The arrangement according to the invention with composite current control as just described readily makes it possible to obtain the sought function of electric transmission.

To compare it with arrangements having separate windings is beyond the scope of this presentation, but nevertheless the following points can be noted qualitatively:
The magnets and associated flux-loop yokes are traversed by pulsing flux components: to forestall the development of eddy currents therein, it is desirable that these magnets have high internal electric resistivity or be divided into elements of short length insulated from one another; similarly, the constitution of the yokes must be adapted to variable fluxes (lamination, “iron powders”, etc.).
As in the arrangements with separate armatures, the question of parasitic coupling between neighboring pancake coils, although disregarded in the first approximation hereinabove, must be taken into consideration: as has already been observed, it may be preferable, as an alternative to spacing apart the pancake coils, to make annular magnetic cutouts in the median spaces between pancake coils in the external and internal yokes of the output rotor.
Overdimensioning of the magnets is necessary:

In fact, the proportionality factor

$$\frac{n \cdot {Λ}_{a j b max}}{2} \cdot 2 \cdot {Θ}_{a j}$$

of the useful torque at θbj corresponds to a magnetizing flux; a coefficient of the same nature would be found in the case of separate windings. Relative thereto, and for comparable geometric dimensions, this factor is degraded by virtue of the elongation of the magnetic path due to the traversing flux structure, suggesting an increase of the current or the dimensions. Precautions relating to the risk of demagnetization of magnets that regularly operate in opposition would have a similar result; the leakage permeances correspond to a parameter for optimization of the dimensioning.

Naturally, the question of demagnetization limit does not come up in asynchronous or reluctance embodiments; the elongation of the magnetic path resulting from the series connection of air gaps affects only the magnetizing components contributed by the winding.
On the other hand, substantial reductions of Joule losses are possible; this is an important consideration in improving efficiency and heating effects:

In fact, for similar geometry, the magnetic potentials θb1 and θb2 required to produce the torques are substantially conserved. As it happens, a cross section corresponding to the sum of the cross sections of the separate reference windings plus potentially the space gained by elimination of yokes is available for housing the single winding; in this way it can be considered roughly that the cross section and volume of copper of the single winding have been multiplied by k>2 compared with one of the foregoing windings. If the reference current density was j in each of the separate windings, the densities j1 and j2 of the composite currents are now each on the order of j/k; except for the special case in which the pulsations ω1 and ω2 are linked, the Joule losses associated with j1 and j2 are simply additive: PJoule=ρ·VCu·(j12+j22); (where ρ is the resistivity of the conductor and Vcu is its global volume); this means that the global Joule losses are then divided by k>2.
Losses in the electronic components can be reduced, leading to further progress in efficiency and in the cost associated with dimensioning.

In fact, considering that the losses in the electronic components are largely related to passage of the current across a loss voltage (IGBT transistors, freewheel diodes of the bridge arm), and that this fraction of the losses is expressed roughly in the form: Losses=Vd*mean(|I|), in the case of separate windings it becomes: Global losses=Vd*mean(|I1·sin ω1t|)+Vd*mean(|I2·sin ω2t|); in typical functioning of the electric transmission without electricity supply, the power of machine 1 is similar to that of machine 2, and this is the case under voltages that are identical except for parasitic drops. This can be expressed by I₁=I₂=I, from which: Global losses=V_{d}*I*(mean(|sin ω₁t|)+mean(|sin ω₂t|)). In the case of composite current control, the same reasoning leads to: Global losses=V_{d}*I*(mean(|sin ω₁t+sin ω₂t|)). The numerical estimates over a time horizon of several periods show that composite current control has an advantage on the order of 35% in terms of these losses (except for very special cases of the type ω₁=ω₂).

An asynchronous alternative embodiment will now be described:

To clarify what has been said about the possibility of embodiments according to the invention using asynchronous active parts in the rotor, FIG. 9 shows an example of adaptation of an asynchronous cage in air gap 1. In this figure, numeral 21 denotes the magnetic yoke of the cage, numeral 22 the surfaces of the ferromagnetic circuit, numeral 23 the short-circuit rings at the ends of the cage, numeral 24 the conductive bars and numeral 25 the nonmagnetic spaces.

It is assumed here that the phase shift required between successive pancake coils is achieved by an angular offset between successive systems of claws. The conductive bars disposed at regular intervals on the periphery of the rotor are thus substantially straight and parallel to the longitudinal axis. (NB: depending on the shape of the claws and the space separating them, it may or may not be desirable to give these bars an inclination relative to their reference direction, as is often done in the usual asynchronous machines in order to smooth out the pulsing phenomena associated with the slotted nature of the stator). The bar ends are electrically connected to one another by conductor rings at each end of the rotor, according to the usual principle of asynchronous cages.

For this cage, however, a first feature relating to the electrical insulation of the conductive bars is to be noted. Parasitic electrical paths between conductive bars must be effectively prevented: each of the segments of a bar located in the air gap of a pancake coil is the site of two electromotive force components associated respectively with the two systems of composite currents; the whole functions with the summation of these emfs over the set of pancake coils; in this way, for example, the parasitic multi-phase component intended for the other rotor leads to a zero summation over all segments of each bar. If intermediate currents can develop in loops via the end rings, they will lead to losses. For this reason, the bars in this case must be insulated from one another along their length. Such insulation can be achieved naturally if the ferromagnetic material used is not a good electrical conductor (case of iron powders); in the case of an embodiment with ferromagnetic sheets, an insulator must be interposed. For the same reason, the ferromagnetic material cannot be monolithic if it is electrically conductive; iron powders, for example, or else stacks of magnetic sheets will therefore be used.

A second feature relates to the nonmagnetic spaces made between the magnetic circuits associated with the different pancake coils: these spaces are visible in FIG. 9. As has already been seen, they constitute an alternative to the spacing of systems of claws in order to limit magnetic coupling via the leaks between pancake coils. Protuberances provided on the bars can function as shims between the ferromagnetic elements separated in this way.

FIG. 10 shows another alternative asynchronous-cage embodiment adapted according to the invention. By way of example, the external part of the rotor, which is shown in section, is illustrated. Once again the general principle is that just described, with bars 24a electrically insulated along their length and electrically connected at their ends by short-circuit rings 23. Nonmagnetic spaces 25 are also provided between pancake coils for decoupling purposes. The special nature is derived from the fact that the conductive bars 24a appear as if they were composed of an assembly of segments whose limits are the boundaries between successive pancake coils; these segments are each substantially straight and parallel to the longitudinal axis, but between one another they have a successive angular offset that can contribute partly or totally to ensuring the required phase shift between pancake coils in this air gap. Electrical continuity between the segments of a bar is ensured at the boundaries between pancake coils by connections that in principle have the shape of arcs of a circle in the plane perpendicular to the longitudinal axis. These connections can function as shims in the nonmagnetic spaces. As already observed hereinabove for the intermediate rotor, the bar segments can have an inclination relative to their reference position, and the basic jitter between the segments can be greatly attenuated or even masked. This embodiment in which the phase shift is achieved in the rotor allows the relative angular position between pancake coils of systems of claws to be chosen without restriction, for example on the basis of criteria of minimizing the leakage permeances between pancake coils. In the matter of phase shifts, it is also possible to act on the order of the pancake coils.

The asynchronous cages can be constructed by varied methods: for example, copper conductive bars can be joined and welded in situ to their end rings. A complete cage, for example of cast aluminum, can also be made in a single step, after which the elements of sectorized magnetic circuits are attached thereto. In the case of use of iron powders, it is even conceivable to press the magnetic material onto the cage. Mechanical stability of these assemblies can be achieved by adhesive bonding, over-molding, banding, etc.

By virtue of the foregoing descriptions, it is now easier to introduce another arrangement according to the invention, to be presented hereinafter.

This arrangement is illustrated in principle in FIG. 11.

As in the foregoing, it is composed of a multi-phase set of n pancake coils, with annular windings 6 installed in a fixed magnetic circuit and two independent rotors 3, 5. As in the traversing-flux stator arrangement just described, each pancake coil receives only one single winding, supplied according to the composite current principle; thus a double multi-phase system with n1 and n2 phases is obtained over the set of windings. However, this stator now opens up directly on only a single air gap instead of two air gaps: it is now closed by a yoke, and only one system of claws remains. The active parts of the two rotors are disposed in concentric manner, facing these claws. The intermediate rotor, or in other words that which is immediately opposite the stator, is of the traversing-flux type: that means that the magnetic flux coupling with the stator largely traverses it radially right through it, in such a way that it interacts with the second rotor. This second rotor in turn is equipped in the usual manner with a yoke that ensures the flux loop.

NB: FIG. 11 represents an intermediate rotor connected to the motive source, the other being connected to the movement output; an inverse choice is possible. Similarly, the rotors are outside the stator, but could be inside it.

Between two successive pancake coils, angular phase shifts adapted to composite current control are imposed: thus the relative setting of the active parts of rotor 3 and of the system of claws of the stator will be 2Π/(p·n1), if p is the number of pairs of claws and n1 is the number of phases of the system associated with rotor 3; similarly, the relative setting of the active parts of rotor 5 and of the system of claws of the stator will be 2Π/(p·n2), where n2 is the number of phases of the system associated with rotor 5.

In this way, following reasoning of the type developed in the foregoing, it can be shown that it is possible to produce stator-rotor 3 and stator-rotor 5 interaction torques in independent manner by composite current control: the first system of currents with n1 phases is set at the electric angular position and therefore the electric pulsation of rotor 3; its amplitude and its phase permit adjustment of the associated torque level. The second system of currents with n2 phases is set at the electric angular position and therefore the electric pulsation of rotor 5; its amplitude and its phase permit adjustment of the associated torque level.

With an appropriate choice of n1 and n2 (for example, among those of FIG. 8), the interaction torque of the first system of currents is globally zero in rotor 5; the same is true for the interaction between the second system of currents and rotor 3. Similarly, the composition of the interactions between the two rotors has a zero resultant.

Numerous choices are possible for the active parts of the two rotors.

FIG. 12 shows a diagram with cage-type asynchronous rotors. The pulsations of each system of currents correspond to p·Ω1·(1−g1) and p·Ω2·(1+g2) respectively, where g1 and g2 are the slippages necessary for establishment of the desired torques, as is known in the controls of asynchronous machines.

In this example of FIG. 12, the embodiment has six pancake coils (n=6) and eight pairs of claws (p=8).

In this figure, numeral 30 denotes the stator assembly comprising six pancake coils, each equipped with a toroidal winding, whose flux is distributed to the air gap by a system of eight pairs of claws 15, 16. The pancake coils are offset successively by 360°/6/8=7.5° in the anti-trigonometric sense.

Numeral 31 denotes a traversing-flux intermediate rotor with asynchronous cage. Its conductive bars 24 extent parallel to the axis of the rotor. The structure of this intermediate rotor is identical to that illustrated in FIG. 9.

Numeral 32 denotes the external rotor with an asynchronous cage.

Its conductive bars are composed of segments parallel to the longitudinal axis and offset successively by 360°/3/8/2=7.5° in the trigonometric sense. Together with the stator it forms a three-phase double machine.

The structure of rotor 32 is identical to that illustrated in FIG. 10.

The intermediate rotor is associated with a multi-phase component of the current wherein n2=6=n/1; the corresponding phase shift of 2Π/(n2 |p) is obtained in this case entirely by the angular spacing of 7.5° of successive systems of claws, and the conductive bars of the asynchronous cage of this intermediate rotor are substantially straight and parallel to the longitudinal axis. NB: depending on the shape of the claws and of the space that separates them, it may or may not be desirable to give these bars an inclination relative to their reference direction, as is often done in the usual asynchronous machines in order to smooth out the pulsing phenomena associated with the slotted nature of the stator. The bar ends are electrically connected to one another by conductor rings at each end of the rotor, according to the usual principle of asynchronous cages.

The other rotor is associated with a multi-phase component of the current wherein n1=3=n/2; half of the corresponding phase shift of 2Π/(n1·p) is achieved by the angular offset of 7.5° of successive systems of claws, as has already been mentioned; the rest of the phase shift is imposed in the opposite sense on the conductive bars themselves of the asynchronous cage of this rotor: a conductive bar therefore has the appearance of being composed of a set of segments whose limits are the boundaries between successive pancake coils; these segments are substantially straight and parallel to the longitudinal axis, but they are offset successively by 7.5°. In this way, the phase shift, over successive pancake coils, between the bar and the system of claws, is 7.5°+7.5°=15°. Electrical continuity between the segments of a bar is ensured at the boundaries between pancake coils by connections that in principle have the shape of arcs of a circle in the plane perpendicular to the longitudinal axis. As already observed hereinabove for the intermediate rotor, the bar segments can have an inclination relative to their reference position, and the basic jitter between the segments can be greatly attenuated or even masked. The bar ends are electrically connected to one another by conductor rings at each end of the rotor, according to the usual principle of asynchronous cages.

The choice adopted in this example in order to achieve the phase shift can naturally comprise numerous different versions: for example, the choice could have been made to distribute the phase shift over the bars of both rotors: the systems of claws would then have been offset by 11.25°=7.5°+½*7.5°; the bars of the intermediate rotor would have been composed of segments offset by 3.75°=½*7.5°, in order to conserve the relative phase shift of 7.5°; conversely, the bars of the external rotor would have been offset at −3.75°. It is understood that it is also possible to act on the order of the pancake coils.

The foregoing comments on the electrical insulation of the bars, the choice of resistive magnetic materials and the limitation of magnetic coupling by leaks between the pancake coils remain valid.

In summary, according to the invention, which is applicable to an electric transmission, the multi-phase stators of the two electric machines are provided with annular windings and are integrated into adjacent spaces; distribution of the alternating flux in the air gap is achieved by the system of claws or of homopolar toothings.

The rotors can be of different types (with magnets, asynchronous, etc.), and in particular of the variable-reluctance, double-saliency type with transverse flux loop to the rotor.

As an alternative version according to the invention, the annular windings of the two stators become one common winding, supplied by composite current control with a single inverter.

The arrangement can then be one of a “traversing-flux” intermediate stator or else a “traversing-flux” intermediate rotor.

1-10. (canceled)

11. An electric transmission, comprising:
two electric machines, a shaft of one of the electric machines being connected to a motive power source, the one machine converting mechanical energy to electrical energy, the other electric machine converting electrical energy to mechanical energy, its shaft being connected to the element to be driven, rotors of both machines being disposed concentrically or axially relative to one another, the rotors cooperating with stators whose windings are disposed inside a space defined by the rotors,
wherein the windings comprise a plurality of annular windings juxtaposed in the space, the windings being supplied by alternating currents shifted in phase relative to one another.

12. An electric transmission according to claim 11, wherein one of the rotors is mounted to rotate on the shaft of the other rotor, and the other rotor drives the rotation of a shaft axially offset from the shaft of the one rotor.

13. An electric transmission according to claim 11, wherein the stator windings are disposed in the space between the two rotors and comprise a first annular layer of windings cooperating with one of the rotors, surrounding a second annular layer of windings cooperating with the other rotor, the two annular layers of windings being connected mechanically to one another.

14. An electric transmission according to claim 11, wherein each winding is disposed in a core of ferromagnetic material covered laterally on each side by an end plate of ferromagnetic material provided opposite the rotor with claws engaged between the claws of the end plate situated on the other side of the core.

15. An electric transmission according to claim 11, wherein each winding is disposed in a core of ferromagnetic material covered laterally on each side by an end plate of ferromagnetic material provided opposite the rotor with teeth pointing toward the rotor.

16. An electric transmission according to claim 11, wherein each rotor is provided at its periphery with a cylindrical yoke of ferromagnetic material, supporting a series of magnets on its internal face pointing toward the stator windings.

17. An electric transmission according to claim 11, wherein each rotor is provided on its periphery with a series of ferromagnetic stubs extending opposite the stator windings.

18. An electric transmission according to claim 11, wherein the annular space between the two rotors is provided with a single series of juxtaposed windings.

19. An electric transmission according to claim 11, wherein peripheral surfaces of the two rotors are adjacent to one another and the annular windings of the stator are situated opposite the internal surface of the rotor that is situated inside the other rotor.

20. An electric transmission according to claim 11, further comprising:
a stator composed of a plurality of juxtaposed pancake coils, each provided with an annular winding and supporting on its periphery ferromagnetic claws engaged between the claws of the periphery of the neighboring pancake coil, an intermediate rotor forming an asynchronous cage provided with conductive bars parallel to the axis of the rotor and a series of ferromagnetic stubs situated between the bars, the intermediate rotor being surrounded by an external rotor provided with conductive bars composed of segments parallel to the rotor axis and offset angularly relative to one another and a series of ferromagnetic stubs situated between the bars.
